(19) United States
(12) Patent Application Publication
(10) Pub. No.: US 2025/0313727 A1
(43) Pub. Date: Oct. 9, 2025

(54) RESIN COMPOSITIONS FOR OPTICALLY CLEAR ADHESIVES AND METHODS OF PREPARING THE SAME

(71) Applicant: Ares Materials Inc., Dallas, TX (US)

(72) Inventors: Sudheendran Mavila, Sachse, TX (US); David Arreaga, Garland, TX (US); Adrian Avendano-Bolivar, Prosper, TX (US)

(21) Appl. No.: 19/173,452

(22) Filed: Apr. 8, 2025

Related U.S. Application Data
(60) Provisional application No. 63/631,713, filed on Apr. 9, 2024.

(51) Int. Cl. C09J 7/30; C09J 11/06; C09J 175/04; G06F 1/16

(52) U.S. Cl. CPC C09J 7/30; C09J 11/06; C09J 175/04; G06F 1/1652; C09J 2301/408

(57) ABSTRACT

An optically clear adhesive (OCA) includes a polymeric resin composition. The polymeric resin composition includes 30 to 60 wt % of a thiol monomer, 20 to 60 wt % of an allyl monomer, and 10 to 30 wt % of a difunctional aliphatic urethane oligomer. The polymeric resin composition further includes 1 to 3 wt % of a hydrolytic stabilizer additive, 0.01 to 0.03 wt % of a wetting additive, 1 to 5 wt % of an adhesion promoting monomer, 0.05 to 2 wt % of an adhesion promoting base; and 0.5 to 2 wt % of a photoinitiator.

### CROSS-REFERENCE TO RELATED APPLICATIONS

This application claims priority to U.S. Provisional Patent Application No. 63/631,713, filed Apr. 9, 2024, and entitled “RESIN COMPOSITIONS FOR OPTICALLY CLEAR ADHESIVES AND METHODS OF PREPARING THE SAME,” the entire disclosure of which is incorporated herein by reference for all purposes.

### BACKGROUND

The advancement of plastic-based electronic devices has resulted in a trend toward durable, lightweight, and foldable designs. Meeting the demands of this trend requires significant innovation in material development to accommodate these flexible applications. Optically clear adhesives (OCA), for example, help to retain elasticity by reducing stress on the display components at a wide range of temperatures during folding. These materials are typically intended to be designed to have a high optical transparency of >90% as well as long-term reliability characteristics including minimal yellowing from heat, humidity, and/or UV exposure.

Currently, technologies utilizing polyacrylate face difficulties in achieving a desirable modulus at temperatures between −20° C. to 60° C. Additionally, using acrylate polymers reduces OCA's polymer network stability when exposed to extreme thermal aging conditions. Maintaining desired optical and thermomechanical properties under high humidity and temperature conditions for extended periods of time is challenging. Achieving high adhesion to various substrate surfaces, such as glass, DOP, and PET, is also challenging. Therefore, based on the foregoing discussion, there is a need to overcome these drawbacks.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of a cross-sectional view of an optical laminate in accordance with certain embodiments of the present disclosure; and

FIG. 2, which is an illustration of a cross-sectional view of a flexible display in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates generally to materials relative to the field of resin compositions for flexible display technologies, and more particularly to the creation of stable, low-modulus, and optically clear adhesives with salient optical, mechanical, and hydrolytic stability. In regards to the present disclosure, the term “adhesive” can include both permanent adhesives and pressure-sensitive adhesives (tacky adhesives). A pressure-sensitive adhesive may be repositionable and may function as a permanent adhesive by being subjected to a post-application treatment such as irradiation or heating with ultraviolet radiation.

In regards to the present disclosure, the term “optically clear” refers to a material having a haze value of approximately 2% or lower across the wavelength range 400 to 700 nm and a luminous transmittance of approximately 90% or higher. It is noted that haze can be determined in accordance with JIS K 7136 (2000) and luminous transmittance can be determined in accordance with JIS K 7361 (1997). Additionally, the term “optically clear” generally refers to a state in which air bubbles cannot be visually observed.

In regards to the present disclosure, the term “storage modulus (G′)” refers to the storage modulus of a material at a specific temperature when a rate of temperature increase is measured at 5° C./min. and viscoelasticity is measured in a 1.0 Hz shear mode within a temperature range of −20° C. to 60° C.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is an optically clear adhesive (OCA) having a polymeric resin composition configured for inclusion in flexible display technologies. The polymeric resin composition comprises 30 to 60 wt % of a thiol monomer, 20 to 60 wt % of an allyl monomer, and 10 to 30 wt % of a difunctional aliphatic urethane oligomer. The polymeric resin composition further comprises 1 to 3 wt % of a hydrolytic stabilizer additive, 0.01 to 0.03 wt % of a wetting additive, 1 to 5 wt % of an adhesion promoting monomer, 0.05 to 2 wt % of an adhesion promoting base, and 0.5 to 2 wt % of a photoinitiator. For flexible display technology applications, the polymeric resin composition is cured into a film.

Additionally presented herein is an optical laminate comprising a first base layer having a first surface, a second base layer having a second surface, and an adhesive layer, where the adhesive layer includes the optically clear adhesive as described in the previous paragraph positioned between the first surface of the first base layer and the second surface of the second base layer so as to adhere the first surface of the first base layer to the second surface of the second base layer.

Additionally presented herein is a flexible display comprising a window layer, a polarizer layer, a display layer, a support film layer and a plurality of adhesive layers, where each of the plurality of adhesive layers include the optically clear adhesive as described in a previous paragraph, further where a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

According to an embodiment of the present disclosure, an optically clear adhesive (OCA) includes a polymeric resin composition configured for inclusion in flexible display technologies. The composition of the adhesive utilizes certain monomers and additive ratios that are configured to increase stability and performance of a typical OCA. The polymeric resin composition comprises 30 to 60 wt % of a thiol monomer, 20 to 60 wt % of an allyl monomer, and 10 to 30 wt % of a difunctional aliphatic urethane oligomer. The polymeric resin composition further comprises 1 to 3 wt % of a hydrolytic stabilizer additive, 0.01 to 0.03 wt % of a wetting additive, 1 to 5 wt % of an adhesion promoting monomer, 0.05 to 2 wt % of an adhesion promoting base, and 0.5 to 2 wt % of a photoinitiator.

For flexible display technology applications, the polymeric resin composition is cured into a film, where the polymeric resin composition is cured into the film using UVA light having an intensity of substantially 4 J/cm² at a temperature between room temperature and 80° C. The film produced embodies a low modulus and further embodies a first storage modulus between 0.05 and 0.2 MPa at −20° C. and a second storage modulus between 0.015 and 0.15 MPa at 60° C. Additionally, the film exhibits excellent optical properties that include a haze of less than 1%, a yellowing index of less than 1, and an optical transmission rate of up to 94% in the 400 nm-700 nm wavelength range. The film further maintains its optical and thermomechanical properties even under high humidity (90%) and temperature (65° C.) for up to 240 hours.

A thiol monomer is a main component of the polymeric resin composition of the OCA.

In certain embodiments, the thiol monomer is difunctional or trifunctional. A “difunctional” monomer, for reference purposes herein, comprises a chemical species that includes two thiolically unsaturated moieties. Similarly, a “trifunctional” monomer comprises a chemical species that includes three thiolically unsaturated moieties. Exemplary difunctional thiols that can be utilized include, but are not limited to: 1,4-bis (3-mercaptobutyroyloxy) butane, ethylene glycol bis-mercaptoacetate, ethylene bis(3-mercaptopropionate), 2,2′-(ethylenedioxy) diethanethiol, or 1,10-decanedithiol. In one embodiment, a species include: 1,4-bis (3-mercaptobutyroyloxy) butane or ethylene bis(3-mercaptopropionate). Exemplary trifunctional thiols that can be utilized include, but are not limited to: trimethylolpropane tris(3-mercaptopropionate) or tris[2-(3-mercaptopropionyloxy)ethyl]isocyanurate. In an embodiment, a species includes: tris[2-(3-mercaptopropionyloxy)ethyl]isocyanurate.

An allyl monomer is another main component of the polymeric resin composition of the OCA. In certain embodiments, the allyl monomer is difunctional or trifunctional (the concept of which is understood in reference to the previous paragraph). Exemplary diallyl monomers that can be utilized include, but are not limited to: diallyl isophthalate, trimethylolpropane diallyl ether, or triethyleneglycol divinyl ether. In an embodiment, a species includes: triethyleneglycol divinyl ether. Exemplary triallyl monomers that can be utilized include, but are not limited to: 1,3,5-triallyl-1,3,5-triazine-2,4,6(1H,3H,5H)-trione or pentaerythritol triallyl ether. In an embodiment, a species includes: 1,3,5-triallyl-1,3,5-triazine-2,4,6(1H,3H,5H)-trione.

A difunctional aliphatic urethane oligomer is another main component of the polymeric resin composition of the OCA. Exemplary difunctional aliphatic urethane oligomers that can be utilized include, but are not limited to: diallyl-trimethylhexamethylene diurethane.

When, in embodiments, the OCA is treated with one of air plasma or corona, the OCA achieves an adhesion force with glass of greater than 1000 gf/in. This amount of adhesive force may be achieved by performing plasma or corona treatment on only the OCA or on both the OCA and a substrate that the OCA is to be affixed to.

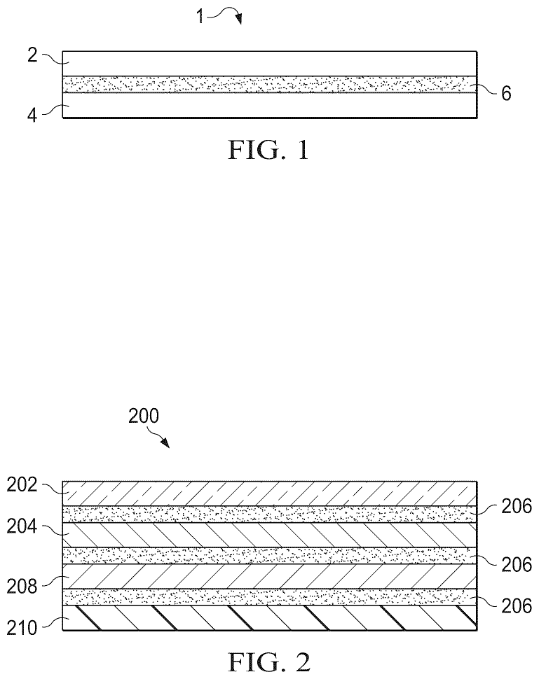

FIG. 1 is an illustration of a cross-sectional view of an optical laminate 1 in accordance with certain embodiments of the present disclosure. As shown, optical laminate 1 includes an adhesive layer 6 including an OCA positioned between and in contact with a first surface of a first base layer 2 and a second surface of a second base layer 4. Adhesive layer 6 may be in direct contact with the first surface of the first base layer 2 and the second surface of the second base layer 4. In other embodiments, adhesive layer 6 may be in indirect contact with the first surface of the first base layer 2 and the second surface of the second base layer 4, where one or more additional layers (not depicted) are positioned between adhesive layer 6 and the first surface of the first base layer 2 and between adhesive layer 6 and the second surface of the second base layer 4. The additional layers may include layers such as, but not limited to, hard coat layers, primer layers, polarizing layers, light emitting layers, or color filter layers. It is further noted that adhesive layer 6 may comprise any embodiment of an OCA disclosed herein.

FIG. 2 is an illustration of a cross-sectional view of a flexible display 200 in accordance with certain embodiments of the present disclosure. As shown, flexible display 200 includes a plurality of layers generally associated with a flexible display and includes a window layer 202, a polarizer layer 204, a display layer 208, and a support film layer 210. An adhesive layer 206 including an OCA is positioned between each pair of layers (202/204, 204/208, and 208/210). More specifically, one adhesive layer 206 of a plurality of adhesive layers 206 is positioned between and in contact with a first surface of window layer 202 and a first surface of polarizer layer 204, another adhesive layer 206 is positioned between and in contact with a second surface of polarizer layer 204 and a first surface of display layer 208, and another adhesive layer 206 is positioned between and in contact with a second surface of display layer 208 and a first surface of support film layer 210.

In other embodiments, adhesive layers 206 may be in indirect contact with the first surface of window layer 202, the first surface of polarizer layer 204, the second surface of polarizer layer 204, the first surface of display layer 208, the second surface of display layer, and the first surface of support film layer 210, where one or more additional layers (not depicted) are positioned between adhesive layers 206 and the first surface of window layer 202, the first surface of polarizer layer 204, the second surface of polarizer layer 204, the first surface of display layer 208, the second surface of display layer, and the first surface of support film layer 210. The additional layers may include layers such as, but not limited to, hard coat layers, primer layers, polarizing layers, light emitting layers, or color filter layers. It is noted that adhesive layers 206 may comprise any embodiment of an OCA disclosed. It is additionally noted that additional layers that are utilized in a flexible display and are separated by additional adhesive layers 206 can be included in the embodiment of flexible display 200, which can be recognized and understood by one skilled in the art.

In any of the disclosed embodiments, each of adhesive layer 6/adhesive layers 206 may comprise a thickness between 25 μm and 500 μm. In an embodiment, each of adhesive layer 6/adhesive layers 206 may comprise a thickness of 50 μm.

According to an embodiment of the present disclosure, a method of synthesizing an adhesion-promoting monomer of the OCA disclosed previously utilizes a process illustrated by following Reaction Formula 1 that is carried out.

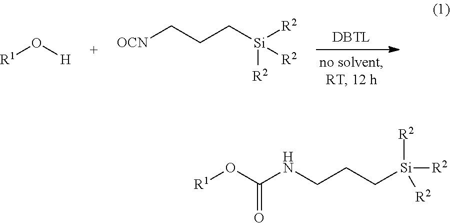

Reactants involved in Reaction Formula 1 include R¹ and R², where R¹ is a compound of Formula 2 or Formula 3

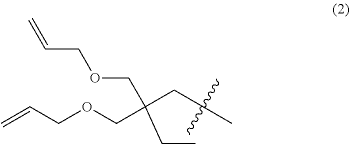 [SMILES: *CC(CC)(COCC=C)COCC=C]

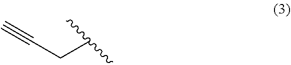 [SMILES: *CC#C]

and R² is a methoxy functional group or an ethoxy functional group.

The process includes combining aliphatic alcohols with 3-isocynatoproyl trialkoxysilane in the presence of a small amount (0.02 to 0.03 wt. %) of dibutyltin dilaurate as a catalyst. The reaction is carried out at room temperature for 12 hours and does not require a solvent for the reaction to be carried out (solvent-free reaction). The adhesion-promoting monomer produced from Reaction Formula 1 comprises trialkoxysilane and at least one photopolymerizable alkene having a functionality greater than 1. Specifically, these adhesion-promoting monomers produced are advantageous over monofunctional acrylate-based silanes in that these monomers can be included in a polymer network without causing chain termination events that result in negative effects on the polymer network's (a material's) mechanical and optical performance.

In the case where the aliphatic alcohols include allyl groups, the allyl groups are orthogonal to isocyanate-alcohol coupling reactions, which enables the reaction to proceed without producing any side products or solvent residues in the final product. This thermal coupling process also produces a versatile non-chain terminating multifunctional trialkoxysilane monomer that embodies excellent hydrolytic stability. This particular monomer, in embodiments can be activated via various approaches, including acid or basic hydrolysis, for example, to enhance the adhesive properties of the OCA. Combining this approach with proper adhesion-promoting amine bases makes it possible to achieve adhesion forces of more than 600 gf/in. between the OCA and different substrates such as, for example, glass, DOP, and PET without any pretreatment or post-treatment.

In embodiments, the aliphatic alcohols comprise photopolymerizable functional groups including any of allyls, alkynes, acrylates, or thiols.

In embodiments, the process includes at least one of a multifunctional diallyl monomer or a multifunctional thiol monomer and (in addition to the at least one of a multifunctional diallyl monomer or a multifunctional thiol monomer) a cross-linker. In an embodiment, when the process includes a multifunctional diallyl monomer, the process comprises a first ratio of a first allyl group in the multifunctional diallyl monomer to a second allyl group in the cross-linker between 5 to 1 and 10 to 1. In another embodiment, when the process includes a multifunctional thiol monomer, the process comprises a second ratio of a first thiol group in the multifunctional thiol monomer to the second allyl group in the cross-linker between 5 to 1 and 10 to 1. These ratios may contribute to a cross-link density and a storage modulus of the product of Reaction Formula 1 within a temperature range between −20° C. and 60° C., as disclosed previously.

In an additional embodiment, when the process includes a multifunctional diallyl monomer, the process comprises a first ratio of a first allyl group in the multifunctional diallyl monomer to a second allyl group in the cross-linker between 5 to 1 and 10 to 1 and a weight percentage of aliphatic urethane oligomer may be between 10 wt % and 25 wt %, which may result in the modulus of the product of Reaction Formula 1 remaining below 0.11 MPa within the −20° C. to 60° C. temperature range. In another embodiment, when the process includes a multifunctional thiol monomer, the process comprises a second ratio of a first thiol group in the multifunctional thiol monomer to the second allyl group in the cross-linker between 5 to 1 and 10 to 1 and a weight percentage of aliphatic urethane oligomer may be between 10 wt % and 25 wt %, which may result in the modulus of the product of Reaction Formula 1 remaining below 0.11 MPa within the −20° C. to 60° C. temperature range.

It is noted that the adhesion-promoting monomer of the process described previously is configured to be synthesized without solvents and is further configured to be stable and safe in normal/typical conditions; this may address any potential safety hazards where chemicals are handled on a large scale. Cured samples of the polymeric resin composition presented previously embody high resistance to thermal degradation, where a weight loss of 1% occurs at temperatures above 180° C. and a weight loss of 5% occurs at temperatures above 310° C. In relation to the synthesized adhesion promoting monomer, for long term storage purposes, the synthesized adhesion-promoting monomer may be stored under an inert atmosphere, which may streamline safe handling and storage of the synthesized adhesion-promoting monomer.

One or more embodiments of this disclosure present materials for constructing higher quality and higher performing flexible display technologies in relation to other flexible display technologies.

It is noted that the optically clear adhesives (OCAs)/polymeric resins presented herein may be utilized in a display/display device/display panel that may be flexible or inflexible. The optically clear adhesives (OCAs)/polymeric resins may be incorporated into one or more layers of the display/display device/display panel that include, but are not limited to: a seal layer, a cathode layer, an emissive layer, an adhesive layer, a conductive layer, an anode layer, a substrate layer, and any layers mentioned in reference to FIG. 2. It is understood that the display/display device/display panel may include additional film layers that are not mentioned herein.

In an embodiment of the present disclosure, an electronic device may be provided that may utilize one or more optically clear adhesives (OCAs)/polymeric resins of the present disclosure in a display/display device/display panel associated with the electronic device. For exemplary purposes, the electronic device may be any of: a smart phone, a mobile phone, a video phone, a camera, a wearable device (such as electronic clothing, an electronic accessory, a smart watch, a head-mounted apparatus, an electronic bracelet, an electronic necklace, or an electronic tattoo), a personal digital assistant (PDA), a desktop computer (PC), a laptop PC, a netbook PC, a portable multimedia player (PMP), a digital audio player, a mobile medical apparatus, an e-book reader, etc. In additional embodiments, electronic device may be a smart home appliance including a display/display device/display panel. For exemplary purposes, the smart home appliance may be any of: an electronic key, a stereo, a TV, a set-top box, a television (TV) box, a video recorder, a game console, a vacuum cleaner, a digital video disk (DVD) player, a refrigerator, an air conditioner, an oven, a dryer, an air purifier, a microwave oven, a washing machine, an electronic dictionary, an electronic photo frame, etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, an optically clear adhesive (OCA) comprising: a polymeric resin composition comprising: 30 to 60 wt % of a thiol monomer; 20 to 60 wt % of an allyl monomer; and 10 to 30 wt % of a difunctional aliphatic urethane oligomer.

Clause 2, the optically clear adhesive of Clause 1, wherein the polymeric resin composition further comprises: 1 to 3 wt % of a hydrolytic stabilizer additive; 0.01 to 0.03 wt % of a wetting additive; 1 to 5 wt % of an adhesion promoting monomer; 0.05 to 2 wt % of an adhesion promoting base; and 0.5 to 2 wt % of a photoinitiator.

Clause 3, the optically clear adhesive of Clause 1, wherein the polymeric resin composition is cured into a film.

Clause 4, the optically clear adhesive of Clause 3, wherein the polymeric resin composition is cured into the film using UVA light having an intensity of substantially 4 J/cm² at a temperature between room temperature and 80° C.

Clause 5, the optically clear adhesive of Clause 3, wherein the film comprises a first storage modulus between 0.05 and 0.2 MPa at −20° C. and a second storage modulus between 0.015 and 0.15 MPa at 60° C.

Clause 6, the optically clear adhesive of Clause 1, wherein the thiol monomer is difunctional or trifunctional.

Clause 7, the optically clear adhesive of Clause 1, wherein the allyl monomer is difunctional or trifunctional.

Clause 8, the optically clear adhesive of Clause 3, wherein the film comprises a haze of less than 1%.

Clause 9, the optically clear adhesive of Clause 3, wherein the film comprises a yellowing index of less than 1.

Clause 10, the optically clear adhesive of Clause 3, wherein the film comprises an optical transmission rate of up to 94% in the 400 nm-700 nm wavelength range.

Clause 11, the optically clear adhesive of Clause 3, wherein the film comprises an adhesion force with glass greater than 1000 gf/in. when treated with at least one of air plasma or corona.

Clause 12, an optical laminate comprising: a first base layer having a first surface; a second base layer having a second surface; and an adhesive layer, wherein the adhesive layer includes an optically clear adhesive (OCA) comprising: a polymeric resin composition comprising: 30 to 60 wt % of a thiol monomer; 20 to 60 wt % of an allyl monomer; and 10 to 30 wt % of a difunctional aliphatic urethane oligomer; wherein the adhesive layer is positioned between the first surface of the first base layer and the second surface of the second base layer so as to adhere the first surface of the first base layer to the second surface of the second base layer.

Clause 13, the optical laminate of Clause 12, wherein the polymeric resin composition further comprises: 1 to 3 wt % of a hydrolytic stabilizer additive; 0.01 to 0.03 wt % of a wetting additive; 1 to 5 wt % of an adhesion promoting monomer; 0.05 to 2 wt % of an adhesion promoting base; and 0.5 to 2 wt % of a photoinitiator.

Clause 14, a method of synthesizing an adhesion-promoting monomer of Clause 2, wherein a process illustrated by following Reaction Formula 1 is carried out.

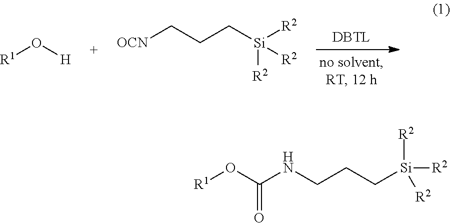

Clause 15, the method of Clause 14, wherein R¹ is a compound of Formula 2 or Formula 3.

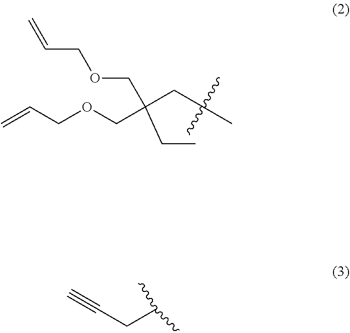

Clause 16, the method of Clause 14, wherein R² is a methoxy functional group or an ethoxy functional group.

Clause 17, the method of Clause 14, wherein the process is carried out solvent-free.

Clause 18, the method of Clause 14, wherein the adhesion-promoting monomer comprises trialkoxysilane.

Clause 19, the method of Clause 14, wherein the adhesion-promoting monomer comprises at least one photopolymerizable alkene having a functionality greater than 1.

Clause 20, the method of Clause 14, wherein the process comprises at least one of a multifunctional diallyl monomer or a multifunctional thiol monomer and a cross-linker, further wherein, when the process includes a multifunctional diallyl monomer, the process comprises a first ratio of a first allyl group in the multifunctional diallyl monomer to a second allyl group in the cross-linker between 5 to 1 and 10 to 1, further wherein, when the process includes a multifunctional thiol monomer, the process comprises a second ratio of a first thiol group in the multifunctional thiol monomer to the second allyl group in the cross-linker between 5 to 1 and 10 to 1.

Clause 21, the method of Clause 14, wherein the adhesion-promoting monomer is cured, further wherein the cured adhesion-promoting monomer comprises a weight loss percentage of 1% at temperatures above 180° C.

Clause 22, a flexible display comprising: a window layer; a polarizer layer; a display layer; a support film layer; and a plurality of adhesive layers; wherein each of the plurality of adhesive layers including includes an the optically clear adhesive (OCA) comprising: a polymeric resin composition comprising: 30 to 60 wt % of a thiol monomer; 20 to 60 wt % of an allyl monomer; and 10 to 30 wt % of a difunctional aliphatic urethane oligomer; wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

Clause 23, the flexible display of Clause 22, wherein the polymeric resin composition further comprises: 1 to 3 wt % of a hydrolytic stabilizer additive; 0.01 to 0.03 wt % of a wetting additive; 1 to 5 wt % of an adhesion promoting monomer; 0.05 to 2 wt % of an adhesion promoting base; and 0.5 to 2 wt % of a photoinitiator.

What is claimed is:

1. An optically clear adhesive (OCA) comprising:
a polymeric resin composition comprising:
30 to 60 wt % of a thiol monomer;
20 to 60 wt % of an allyl monomer; and
10 to 30 wt % of a difunctional aliphatic urethane oligomer.

2. The optically clear adhesive of claim 1, wherein the polymeric resin composition further comprises:
1 to 3 wt % of a hydrolytic stabilizer additive;
0.01 to 0.03 wt % of a wetting additive;
1 to 5 wt % of an adhesion promoting monomer;
0.05 to 2 wt % of an adhesion promoting base; and
0.5 to 2 wt % of a photoinitiator.

3. The optically clear adhesive of claim 1, wherein the polymeric resin composition is cured into a film.

4. The optically clear adhesive of claim 3, wherein the polymeric resin composition is cured into the film using UVA light having an intensity of substantially 4 J/cm² at a temperature between room temperature and 80° C.

5. The optically clear adhesive of claim 3, wherein the film comprises a first storage modulus between 0.05 and 0.2 MPa at −20° C. and a second storage modulus between 0.015 and 0.15 MPa at 60° C.

6. The optically clear adhesive of claim 1, wherein the thiol monomer is difunctional or trifunctional.

7. The optically clear adhesive of claim 1, wherein the allyl monomer is difunctional or trifunctional.

8. The optically clear adhesive of claim 3, wherein the film comprises a haze of less than 1%.

9. The optically clear adhesive of claim 3, wherein the film comprises a yellowing index of less than 1.

10. The optically clear adhesive of claim 3, wherein the film comprises an optical transmission rate of up to 94% in the 400 nm-700 nm wavelength range.

11. The optically clear adhesive of claim 3, wherein the film comprises an adhesion force with glass greater than 1000 gf/in. when treated with at least one of air plasma or corona.

12. An optical laminate comprising:
a first base layer having a first surface;
a second base layer having a second surface; and
an adhesive layer, wherein the adhesive layer includes an optically clear adhesive (OCA) comprising:
a polymeric resin composition comprising:
30 to 60 wt % of a thiol monomer;
20 to 60 wt % of an allyl monomer; and
10 to 30 wt % of a difunctional aliphatic urethane oligomer;
wherein the adhesive layer is positioned between the first surface of the first base layer and the second surface of the second base layer so as to adhere the first surface of the first base layer to the second surface of the second base layer.

13. The optical laminate of claim 12, wherein the polymeric resin composition further comprises:
1 to 3 wt % of a hydrolytic stabilizer additive;
0.01 to 0.03 wt % of a wetting additive;
1 to 5 wt % of an adhesion promoting monomer;
0.05 to 2 wt % of an adhesion promoting base; and
0.5 to 2 wt % of a photoinitiator.

14. A method of synthesizing an adhesion-promoting monomer of claim 2, wherein a process illustrated by following Reaction Formula 1 is carried out.

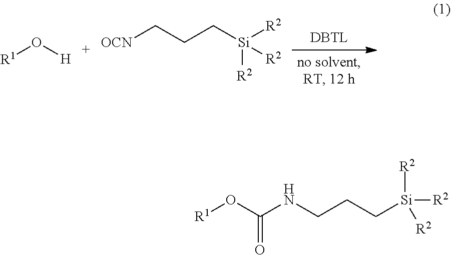

15. The method of claim 14, wherein R¹ is a compound of Formula 2 or Formula 3.

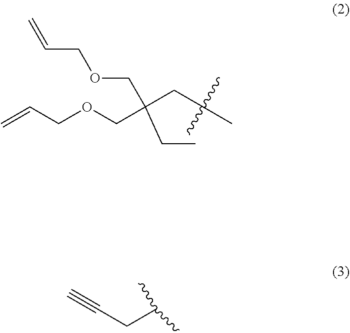

16. The method of claim 14, wherein R² is a methoxy functional group or an ethoxy functional group.

17. The method of claim 14, wherein the process is carried out solvent-free.

18. The method of claim 14, wherein the adhesion-promoting monomer comprises trialkoxysilane.

19. The method of claim 14, wherein the adhesion-promoting monomer comprises at least one photopolymerizable alkene having a functionality greater than 1.

20. The method of claim 14, wherein the process comprises at least one of a multifunctional diallyl monomer or a multifunctional thiol monomer and a cross-linker, further wherein, when the process includes a multifunctional diallyl monomer, the process comprises a first ratio of a first allyl group in the multifunctional diallyl monomer to a second allyl group in the cross-linker between 5 to 1 and 10 to 1, further wherein, when the process includes a multifunctional thiol monomer, the process comprises a second ratio of a first thiol group in the multifunctional thiol monomer to the second allyl group in the cross-linker between 5 to 1 and 10 to 1.

21. The method of claim 14, wherein the adhesion-promoting monomer is cured, further wherein the cured adhesion-promoting monomer comprises a weight loss percentage of 1% at temperatures above 180° C.

22. A flexible display comprising:
a window layer;
a polarizer layer;
a display layer;
a support film layer; and
a plurality of adhesive layers, wherein each of the plurality of adhesive layers includes an optically clear adhesive (OCA) comprising:
a polymeric resin composition comprising:
30 to 60 wt % of a thiol monomer;
20 to 60 wt % of an allyl monomer; and
10 to 30 wt % of a difunctional aliphatic urethane oligomer;
wherein a first adhesive layer of the plurality of adhesive layers is positioned between a first surface of the window layer and a first surface of the polarizer layer, a second adhesive layer is positioned between a second surface of the polarizer layer and a first surface of the display layer, and a third adhesive layer is positioned between a second surface of the display layer and a first surface of the support film layer so as to adhere the first surface of the window layer to the first surface of the polarizer layer, the second surface of the polarizer layer to the first surface of the display layer, and the second surface of the display layer to the first surface of the support film layer.

23. The flexible display of claim 22, wherein the polymeric resin composition further comprises:
1 to 3 wt % of a hydrolytic stabilizer additive;
0.01 to 0.03 wt % of a wetting additive;
1 to 5 wt % of an adhesion promoting monomer;
0.05 to 2 wt % of an adhesion promoting base; and
0.5 to 2 wt % of a photoinitiator.
